(19) United States
(12) Patent Application Publication
(10) Pub. No.: US 2007/0199246 A1
(43) Pub. Date: Aug. 30, 2007

(54) Window regulator cable drum

(76) Inventors: David T. Renke, Macomb, MI (US); Ronald J. Renke, Rochester, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/363,711

(22) Filed: Feb. 28, 2006

(51) Int. Cl. E05F 11/48

(52) U.S. Cl. 49/352

(57) ABSTRACT

The invention concerns a cable drum having a non-cylindrical profile of its outer surface and the use of this cable drum in a window regulator system, particularly in a vehicle. The window regulator system may include a slider assembly adapted to engage a movable window and move along a pre-defined path, a cable assembly operatively engaging the slider assembly, a cable drum having a first end, an opposed second end, and an outer surface extending substantially from the first end to the second end, with the outer surface having a non-cylindrical profile about which a portion of the cable assembly wraps; and a drive unit operatively engaging the cable drum to selectively cause the cable drum to rotate.

### BACKGROUND OF INVENTION

The present invention relates generally to window regulators that are employed to raise and lower windows in vehicles.

Window regulator assemblies are employed to raise and lower windows in vehicles. Such window regulator assemblies may employ a switch to operate a motor, which raises and lowers the window—commonly called a power window. Some power window systems use slider assemblies that are secured to the window and move up and down on guide rails. These slider assemblies may be pulled up and down by a cable assembly, which is driven by a cable drum mounted to the output shaft of the motor. The other ends of the cable assemblies attach to the slider assemblies. The cable drum has a generally cylindrical shape and the cables are wound onto and off of the drum by activating the motor in one direction or the other. Rotation of the cable drum, then, causes the cables to pull the slider assemblies up (to close the window) or to pull the slider assemblies down (to open the window). With a motor having a single speed, and the cable drum being cylindrical, the travel speed and the pull force are constant throughout the entire length of window travel.

A constant travel speed and pull force may not be desirable for certain window opening/closing conditions. For example, it may be desirable to have a larger pull force at the end of upward (i.e., closing) travel to overcome window seal resistance. Also, it might be desirable to have a larger pull force at the beginning of downward (i.e., opening) travel to overcome seal resistance or release a frozen window. In addition, it might be desirable to increase the travel speed of the window in the mid-travel range, with a slower travel speed at each end of travel. There may be other types of variations in travel speed and pull force that may be desirable for the operation of a window regulator assembly. Such variation in the travel speed and/or pull force during window opening and closing may be possible by employing a controller with some type of a hardware and/or software control function that will provide for the variability desired. But this may increase the size of motor required, and would increase the number of parts and complexity of the window regulator assembly. Consequently, such a solution may be more costly and complex than is desired for a window regulator assembly.

### SUMMARY OF INVENTION

An embodiment of the present invention contemplates a window regulator system. The window regulator system may include a slider assembly adapted to engage a movable window and move along a pre-defined path, a cable assembly operatively engaging the slider assembly, a cable drum having a first end, an opposed second end, and an outer surface extending substantially from the first end to the second end, with the outer surface having a non-cylindrical profile about which a portion of the cable assembly wraps, and a drive unit operatively engaging the cable drum to selectively cause the cable drum to rotate.

An embodiment according to the present invention may contemplate a cable drum for use in a window regulator system of a vehicle having a first end, an opposed second end, and an outer surface extending substantially from the first end to the second end, with the outer surface having a non-cylindrical profile, and with the non-cylindrical profile of the outer surface adapted to receive a portion of a cable assembly therearound.

An advantage of an embodiment of the present invention is that the window regulator system can move the window with a variable travel speed and variable pull force. This ability to vary the travel speed and pull force is accomplished without requiring a controller with additional hardware and/or software, thus minimizing the cost and complexity of the window regulator system.

An advantage of an embodiment of the present invention is that the motor size can be reduced by shaping the profile of the cable drum to reduce the maximum torque output required by the motor to produce the required pull force at each portion of window travel. A smaller motor may improve packaging, and reduce the mass and cost of the motor. For example, the pull force can be increased at the end of upward travel to overcome seal resistance, and/or at the beginning of downward travel to overcome seal resistance or release a frozen window. Additionally, the travel speed of the window can be increase in the mid-travel range to assure relatively quick movement between the fully closed and fully open positions.

### BRIEF DESCRIPTION OF DRAWINGS

FIG. 1 is a somewhat schematic, partially exploded, perspective view of a portion of window regulator system for a vehicle window, in accordance with the present invention.

FIG. 2 is an enlarged view of a portion of the window regulator system of FIG. 1.

FIG. 3 is a schematic view of a cable drum and cable of a window regulator system for a vehicle window, in accordance with the present invention.

### DETAILED DESCRIPTION

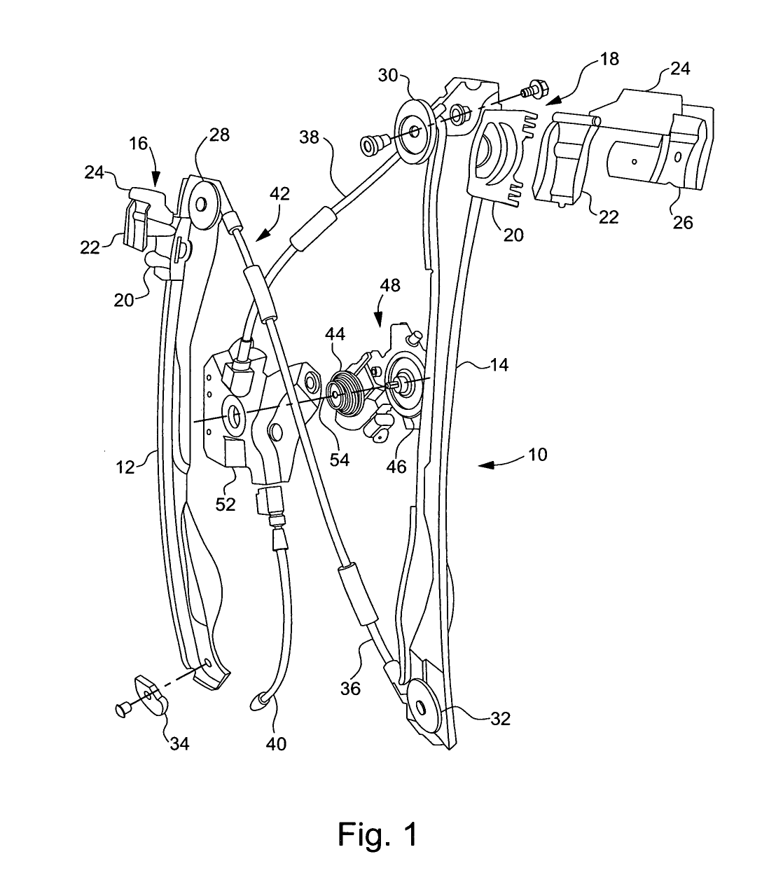

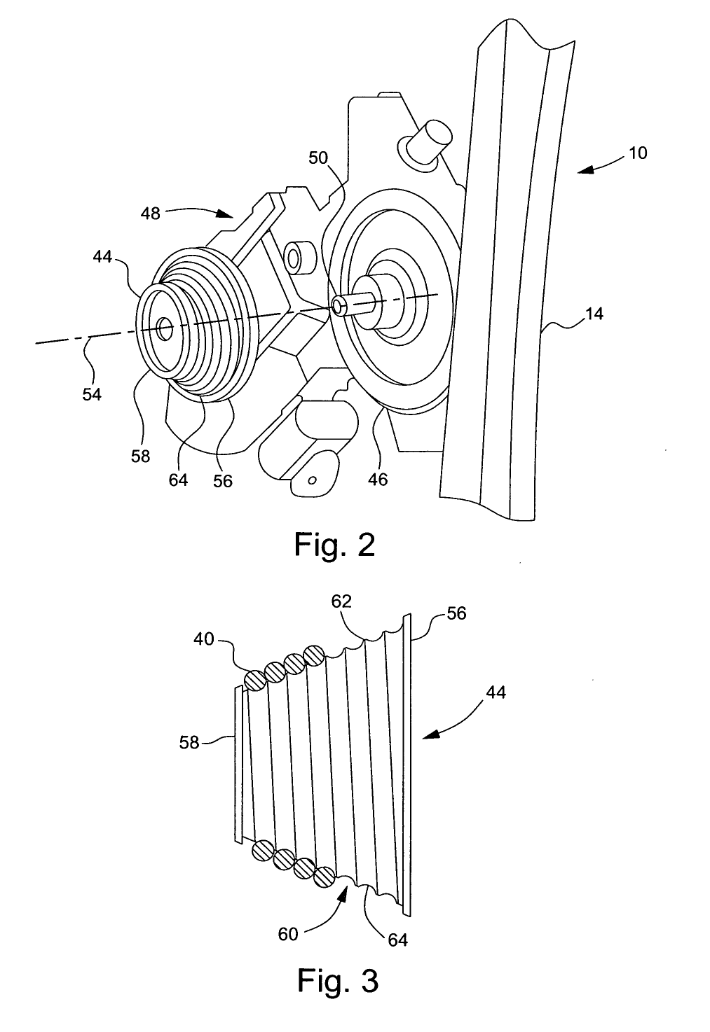

FIGS. 1-3 illustrate a window regulator system, indicated generally at 10, for raising and lowering a vehicle window (not shown). The window regulator system 10 includes a first guide rail 12 and a second guide rail 14, which mount to vehicle structure, such as a door (not shown), in a conventional manner.

A first slider assembly 16 mounts to the first guide rail 12 and a second slider assembly 18 mounts to the second guide rail 14. The guide rails 12, 14 define the paths along which the slider assemblies 16, 18 move. Each slider assembly 16 may include a slider 20 (mounted to a respective guide rail), a clamp plate 22, a friction pad 24 that mounts between the slider 20 and clamp plate 22 and engages the window, and a lift plate 26. The slider assemblies 16, 18 may be conventional and so will not be discussed or shown in greater detail herein.

The first guide rail 12 may also have an upper pulley 28 and a lower pulley (not shown), and a down stop 34 mounted thereon, and the second guide rail 14 may have an upper pulley 30 and a lower pulley 32 mounted thereon. Alternatively, other mechanisms for redirecting and allowing a sliding motion of a stretched cable may be employed instead of the pulleys, if so desired.

A cable assembly 42 may include a first cable 36, a second cable 38 and a third cable 40. The cables 36, 38, 40 may each have an outer casing and an inner core, as is known to those skilled in the art. The inner cores of the cables 36, 38 are not shown herein, and the inner core of the cable 40 is shown only in FIG. 3. The first cable 36 connects at a first end to the first slider assembly 16 and at a second end to the second slider assembly 18. The first cable 36 also extends around the upper pulley 28 and the lower pulley 32.

The second and third cables 38, 40 in the cable assembly 42 include first ends that are attached to a cable drum 44 (discussed below), and wind around or unwind from the drum 44 depending upon the direction the drum rotates. The second cable 38 includes a second opposing end that is secured to the second slider assembly 18, and is mounted around the upper pulley 30. The third cable 40 includes a second opposing end that is secured to the first slider assembly 16. Alternatively, the second and third cables 38, 40 connected to the cable drum 44 can be a single cable wrapped around the drum 44, with first and second ends connected to respective slider assemblies 16,18.

The cable assembly, then, forms a pull-pull type of system between the cable drum 44 and the slider assemblies 16, 18. That is, depending upon the direction of rotation of the motor 46, the cables 36, 38, 40 will pull the slider assemblies 16, 18 up along the guide rails 12, 14 or will pull the slider assemblies 16, 18 down along the guide rails 12, 14. The slider assemblies 16, 18, cables 36, 38, 40 and pulleys 28, 30, 32 are operative in a known manner in response to the actuation of the motor 46 to raise and lower the slider assemblies 16, 18, and thereby raise and lower the window, and so will not be discussed in greater detail herein.

The window regulator system 10 also includes a drive unit 48, which includes the bidirectional motor 46. The drive unit 48 is fixed relative to the guide rails 12, 14. The supply of power to and control of the motor 46 can be conventional and so will not be discussed further herein. The motor 46 has an output shaft 50, with the cable drum 44 mounted to and driven by the output shaft 50 about an axis 54. The drive unit 48 may also include a drum housing 52 that covers and protects the drum 44 and cables 38, 40.

The cable drum 44 has a first end 56 that mounts adjacent to the motor 46 and an opposed second end 58 facing away from the motor 46. An outer surface 60 extends generally between the first and second ends 56, 58 (best seen in FIG. 3). This outer surface 60 has a profile 62 that is a generally frustum-conical shape—being radially larger near the first end 56 and tapering down toward the second end 58. For the motor 46 driving the drum 44 at a given speed, then, a cable winding on the drum 44 near the first end 56 will have greater travel speed but less pull force than when winding on the drum 44 near the second end 58. Thus, this window regulator system 10 has a variable travel speed/pull force, even without employing special electronics or a variable speed motor—although, if so desired, one may add these features to the system as well.

The outer surface 60 of the cable drum 44 may have a helical shaped cable groove 64 to receive the cable 40 as the drum 44 turns. This cable groove 64 causes the cable 40 to track in a predictable manner (i.e., preventing it from slipping up or down the drum profile 62), thus providing proper tensioning and travel speed/pull force for each position of the vehicle window (not shown). The depth, width and spacing of the cable groove 64 can be any suitable dimensions for assuring that the cable 40 tracks on the drum 44 in the desired manner. Alternatively, a different means for causing the cable to track around the drum in a predictable manner may be employed instead of the cable groove, if so desired.

When referring to the profile 62 of the outer surface 60 herein, this refers to the overall general shape of this surface 60, whether or not it includes the cable groove 64. Accordingly, for a conventional cable drum, the profile is cylindrical (i.e., a generally constant diameter extending axially from near the first end to near the second end), whether or not the outer surface has a cable groove. In the example shown in FIGS. 1-3, then, the profile 62 of the outer surface 60 is considered to be frustum-conical (i.e., a larger diameter near the first end 56 tapering down to a smaller diameter near the second end 58), even though the outer surface 60 includes the cable groove 64.

As an alternative to the profile 62 illustrated in FIGS. 1-3, the profile of the cable drum 44 may radially taper down extending toward the motor 46 rather than as shown radially tapering down as it extends away from the motor 46. As another alternative, the cable drum 44 may have other non-cylindrical outer surface profile shapes, as desired, to obtain the desired variations in window travel speed/pull force relative to corresponding window open positions. For example, the cable drum may have a profile shape being a pair of frustum-cones back-to-back, with the first frustum-cone being adjacent to the first end and extending toward the second end and the second frustum-cone being adjacent to the second end and extending toward the first end until it meets the first frustum-cone. In this example, if the pair of frustum-cones radially taper down from the middle out toward the first and second ends, respectively, then the window travel speed would vary slow-fast-slow. On the other hand, if, in this example, the pair of frustum-cones radially taper down from each end toward the middle, then the window travel speed would vary fast-slow-fast. Or, as a further alternative, the outer surface profile shape may have only a portion that is cylindrical and another portion that is not so that the overall profile is non-cylindrical, with the travel speed/pull force being constant over a portion of the window travel and varying over another portion of the window travel.

While certain embodiments of the present invention have been described in detail, those familiar with the art to which this invention relates will recognize various alternative designs and embodiments for practicing the invention as defined by the following claims.

What is claimed is:

1. A window regulator system comprising:
a slider assembly adapted to engage a movable window and move along a pre-defined path;
a cable assembly operatively engaging the slider assembly;
a cable drum having a first end, an opposed second end, and an outer surface extending substantially from the first end to the second end, with the outer surface having a non-cylindrical profile about which a portion of the cable assembly wraps; and
a drive unit operatively engaging the cable drum to selectively cause the cable drum to rotate.

2. The window regulator system of claim 1 wherein the non-cylindrical profile is a frustum-conical shape radially tapering down from adjacent to the first end toward the second end.

3. The window regulator system of claim 2 wherein the first end of the cable drum is adjacent to the drive unit.

4. The window regulator system of claim 3 wherein the outer surface includes a cable groove for receiving the portion of the cable assembly that wraps around the cable drum.

5. The window regulator system of claim 2 wherein the outer surface includes a cable groove for receiving the portion of the cable assembly that wraps around the cable drum.

6. The window regulator system of claim 1 wherein the outer surface includes a cable groove for receiving the portion of the cable assembly that wraps around the cable drum.

7. The window regulator system of claim 6 wherein the cable groove is a helical shaped groove.

8. The window regulator system of claim 1 wherein the drive unit includes an electric motor with an output shaft operatively engaging the cable drum.

9. The window regulator system of claim 1 further including a second slider assembly adapted to engage the movable window and move along a pre-defined path, a first guide rail having the slider assembly slidably mounted thereon, and a second guide rail having the second slider assembly slidably mounted thereon.

10. A cable drum for use in a window regulator system of a vehicle comprising:
a first end;
an opposed second end; and
an outer surface extending substantially from the first end to the second end, with the outer surface having a non-cylindrical profile, and with the non-cylindrical profile of the outer surface adapted to receive a portion of a cable assembly therearound.

11. The cable drum of claim 10 wherein the non-cylindrical profile is a frustum-conical shape radially tapering down from adjacent to the first end toward the second end.

12. The cable drum of claim 11 wherein the outer surface includes a helical shaped cable groove for receiving the portion of the cable assembly.

13. The cable drum of claim 10 wherein the outer surface includes a cable groove for receiving a portion of the cable assembly.

14. The cable drum assembly of claim 13 wherein the cable groove is a helical shaped groove.

15. The cable drum of claim 10 wherein the non-cylindrical profile is a frustum-conical shape radially tapering down from adjacent to the first end to adjacent to the second end.

16. A window regulator system for use with a movable vehicle window comprising:
a pair of slider assemblies adapted to engage the movable window and move along a pre-defined path;
a cable assembly operatively engaging the slider assemblies; and
a cable drum having a first end, an opposed second end, and an outer surface extending substantially from the first end to the second end, with the outer surface having a frustum-conical profile about which a portion of the cable assembly wraps.

17. The window regulator system of claim 16 wherein the frustum-conical profile radially tapers down from adjacent to the first end to adjacent to the second end.

18. The window regulator system of claim 17 wherein the outer surface includes a cable groove for receiving the portion of the cable assembly that wraps around the cable drum.

19. The window regulator system of claim 16 further including a pair of guide rails each having as respective one of the pair of slider assemblies slidably mounted thereon.

20. The window regulator system of claim 16 further including a drive unit having an electric motor with an output shaft operatively engaging the cable drum.
